(19) United States
(12) Patent Application Publication
(10) Pub. No.: US 2016/0191458 A1
(43) Pub. Date: Jun. 30, 2016

(54) METHOD, A DEVICE, AND A DATA TRANSMISSION SYSTEM FOR DATA TRANSMISSION IN A NETWORK SYSTEM

(71) Applicant: Tencent Technology (Shenzhen) Company Limited, Shenzhen (CN)

(72) Inventor: Ming RAO, Shenzhen (CN)

(73) Assignee: Tencent Technology (Shenzhen) Company Limited, Shenzhen (CN)

(21) Appl. No.: 15/060,321

(22) Filed: Mar. 3, 2016

Related U.S. Application Data
(63) Continuation of application No. PCT/CN2014/094821, filed on Dec. 24, 2014.

(30) Foreign Application Priority Data
Dec. 31, 2013 (CN) 201310751777.7

(51) Int. Cl. H04L 29/12; H04L 12/851

(52) U.S. Cl. CPC H04L 61/2007; H04L 47/2483

(57) ABSTRACT

A method, a device, and a data transmission system are provided for data transmission in a network system. In the method, an acceleration node receives a packet that is sent from a sending end to a receiving end, where the acceleration node is located between the sending end and receiving end and at least one of the sending end and receiving end being the central node or the acceleration node. The acceleration node determines the transmission type of the packet according to the source information about the packet and the destination information about the packet. The acceleration node then forwards the packet at said acceleration node by using the processing logic corresponding to the transmission type of said packet.

### CROSS-REFERENCE TO RELATED APPLICATIONS

This application is a continuation of International Application No. PCT/CN2014/094821, filed Dec. 24, 2014, which claims priority to Chinese Patent Application No. 201310751777.7, filed on Dec. 31, 2013, both of which are hereby incorporated by reference in their entirety.

### FIELD

The disclosure relates to the field of data transmission, and more particularly to a method, a device, and a data transmission system used for data transmission in a network system.

### BACKGROUND

When a user performs an operation, such as a communication operation, by using a mobile client, the communication process is completed only after the client sends the user packets to the receiving server by using a mobile network and the user packets arrive at said server for processing. A complicated network environment may be involved in the process of communication between the mobile client and the server. A common problem is that the distance between the mobile client and the server is long. When packets are transmitted over a long distance, network congestion and packet loss often occur, particularly in the case of inter-province transmission and transmission across the networks run by different operators. Consequently, the stability and the success rate of packet transmission between the mobile client and the server are unsatisfactory.

As such, a new data transmission method is needed to accelerate data transmission.

### SUMMARY

In view of the problem as stated above, it is necessary to provide a method, a device, and a data transmission system for data transmission in a network system to accelerate data transmission between a sending end and a receiving end.

In a first aspect, a method is provided for data transmission in a network system. The network system includes a central node and at least one acceleration node. In the method, the acceleration node receives a packet that is sent from a sending end to a receiving end. The acceleration node is located between said sending end and receiving end, and at least one of said sending end and receiving end being said central node or acceleration node. The acceleration node determines the transmission type of said packet in said acceleration node according to the source information of said packet and the destination information of said packet. The acceleration node forwards the packet at said acceleration node by using the processing logic corresponding to the transmission type of said packet.

In a second aspect, a device is provided for data transmission in a network system, where the network system includes a central node and at least one acceleration node. The device includes a hardware processor and a non-transitory storage medium configured to store modules: a receiving module, a determination module, and a forwarding module. The receiving module is configured to receive, at said acceleration node, a packet that is sent from the sending end to the receiving end, said acceleration node being located between said sending end and receiving end, and at least one of said sending end and receiving end being said central node or acceleration node. The determination module is configured to determine the transmission type of said packet in said acceleration node according to the source information of said packet and the destination information of said packet. The forwarding module is configured to forward the packet on said acceleration node by using the processing logic corresponding to the transmission type of said packet.

In a third aspect, a data transmission system includes a sending end, a receiving end, and an acceleration node located between said sending end and receiving end. The sending end is configured to send a packet destined for the receiving end to said acceleration node. The acceleration node is configured to receive the packet that is sent from said sending end to the receiving end, to determine the transmission type of said packet in said acceleration node according to the source information of said packet and the destination information of said packet, and to forward said packet at said acceleration node by using the processing logic corresponding to the transmission type of said packet.

The data transmission system according to this embodiment can quickly forward to the receiving end the data sent by the sending end, thus accelerating data transmission between the sending end and the receiving end.

To facilitate understanding of the above purpose and other purposes, characteristics, and benefits of the present disclosure, the following describes in detail the preferred embodiments of the present disclosure in combination with drawings.

### BRIEF DESCRIPTION OF THE DRAWINGS

Accompanying drawings used in the embodiments and prior art are briefly introduced to make further illustration on the technical scheme of embodiments of the disclosure and prior art. It is apparent that the described accompanying drawings are only specific embodiments of the disclosure. Person of skill in the art may get other accompanying drawings according to the drawings above without any creative labor.

FIG. 1 shows the structural diagram of a data transmission system provided by example embodiments.

FIG. 2 shows the structural block diagram of the central node of the data transmission system as shown in FIG. 1.

FIG. 3 shows the structural block diagram of the acceleration server in the acceleration node of the data transmission system as shown in FIG. 1.

FIG. 4 shows the structural block diagram of the mobile terminal in the central node of the data transmission system as shown in FIG. 1.

FIG. 5 shows the schematic diagram of the interaction in the data transmission system.

FIG. 6 shows the flow of the method for data transmission in a network system provided by embodiments.

FIG. 7 shows a part of the flow of the method for data transmission in a network system provided by embodiments.

FIG. 8 shows a part of the flow of the method for data transmission in a network system provided by embodiments.

FIG. 9 shows a part of the flow of the method for data transmission in a network system provided by embodiments.

FIG. 10 shows a part of the flow of the method for data transmission in a network system provided by embodiments.

FIG. 11 shows the structural block diagram of the device for data transmission in a network system provided by embodiments.

FIG. 12 shows the structural block diagram of the device for data transmission in a network system provided by embodiments.

FIG. 13 shows the structural block diagram of the device for data transmission in a network system provided by embodiments.

FIG. 14 shows the structural block diagram of the device for data transmission in a network system provided by embodiments.

FIG. 15 shows the structural block diagram of the device for data transmission in a network system provided by embodiments.

### DETAILED DESCRIPTION OF THE DRAWINGS

Reference throughout this specification to “embodiments,” “an embodiment,” “example embodiment,” or the like in the singular or plural means that one or more particular features, structures, or characteristics described in connection with an embodiment is included in at least embodiments of the present disclosure. Thus, the appearances of the phrases “in embodiments” or “in an embodiment,” “in an example embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “module” or “unit” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module or unit may include memory (shared, dedicated, or group) that stores code executed by the processor.

The exemplary environment may include a server, a client, and a communication network. The server and the client may be coupled through the communication network for information exchange, such as sending/receiving identification information, sending/receiving data files such as splash screen images, etc. Although only one client and one server are shown in the environment, any number of terminals or servers may be included, and other devices may also be included.

The communication network may include any appropriate type of communication network for providing network connections to the server and client or among multiple servers or clients. For example, communication network may include the Internet or other types of computer networks or telecommunication networks, either wired or wireless. In a certain embodiment, the disclosed methods and apparatus may be implemented, for example, in a wireless network that includes at least one client.

In some cases, the client may refer to any appropriate user terminal with certain computing capabilities, such as a personal computer (PC), a work station computer, a server computer, a hand-held computing device (tablet), a smart phone or mobile phone, or any other user-side computing device. In various embodiments, the client may include a network access device. The client may be stationary or mobile.

A server, as used herein, may refer to one or more server computers configured to provide certain server functionalities, such as database management and search engines. A server may also include one or more processors to execute computer programs in parallel.

The solutions in the embodiments of the present disclosure are clearly and completely described in combination with the attached drawings in the embodiments of the present disclosure. Obviously, the described embodiments are only a part, but not all, of the embodiments of the present disclosure. On the basis of the embodiments of the present disclosure, all other embodiments acquired by those of ordinary skill in the art under the precondition that no creative efforts have been made shall be covered by the protective scope of the present disclosure.

In order to make the objectives, technical solutions, and advantages of the present disclosure more comprehensible, the present disclosure is further described in detail below with reference to embodiments and the accompanying drawings.

To further elaborate the technical means and the effects of the present disclosure to achieve the intended purposes, the following further describes the implementation mode, the structure, the characteristics, and the effects of the present disclosure in combination with drawings and preferred embodiments.

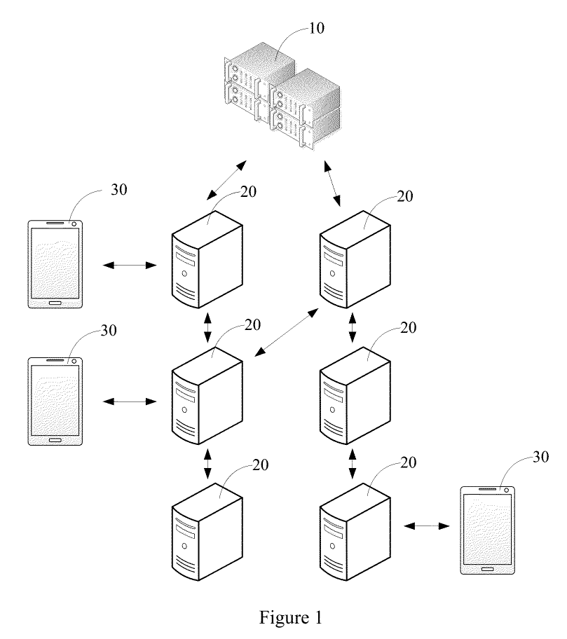

FIG. 1 shows the structural diagram of the data transmission system provided by embodiment 1. As shown in FIG. 1, the data transmission system 100 comprises one or more (only one shown in FIG. 1) central nodes 10, one or more (only one shown in FIG. 1) acceleration nodes 20, and multiple mobile terminals 30. The central node 10 may be a data center and include multiple servers, which are configured to respectively provide different services or to provide a single service by adopting the distributed architecture.

Multiple acceleration nodes 20 may be deployed in different geographical locations. For example, one acceleration node 20 may be deployed in each city, region, and country. The acceleration node 11 may also include one or more acceleration servers. The central node 20 and the acceleration node 11 are interconnected by using a high-speed Internet connection, for example, by using an optical fiber network and a satellite communication network.

The mobile terminal 30 may be connected to the Internet by using a wireless network and to the acceleration node 20 or the central node 10 via the Internet.

As shown in FIG. 1, the data sent by the mobile terminal 30 may be forwarded to the central node 10 through level-1 acceleration nodes or forwarded to the central node 10 through the level-2 or more levels of acceleration nodes 20. That is, for uplink data (from the mobile terminal 30 to the central node 10), the acceleration node 20 may receive the data sent by the mobile terminal 30 or other acceleration nodes; having passed through the acceleration node 20, the data may be sent to the central node 10 or other acceleration nodes 20. In other words, the acceleration node 20 can play different roles during forwarding of network data. That is, the transmission types of different packets in each acceleration node 20 are different. Depending on the sources and destinations of the packets, the transmission types of packets in acceleration nodes 20 may be classified into access, transfer, hybrid, and delivery. The following table describes the classification rules:

| | | Packet source | |
|---|---|---|---|
| Transmission types of packets | | Mobile terminal | Acceleration node |
| Packet | Acceleration node | Access | Transfer |
| destination | Central node | Hybrid | Delivery |

In one acceleration node 20, if a received packet is sourced from the mobile terminal 30 used by a user and destined for another acceleration node 20, the transmission type of said packet in the acceleration node 20 is access.

In one acceleration node 20, if a received packet is sourced from another acceleration node 20 and destined for yet another acceleration node 20, the transmission type of said packet in the acceleration node 20 is transfer.

In one acceleration node 20, if a received packet is sourced from the mobile terminal 30 used by a user and destined for the central node 10, the transmission type of said packet in the acceleration node 20 is hybrid.

In one acceleration node 20, if a received packet is sourced from another acceleration node 20 and destined for the central node 10, the transmission type of said packet in the acceleration node 20 is delivery.

An acceleration node 20 uses different processing logics to process a packet based on its transmission types. For example, data transfer is performed by using the transmission channel corresponding to the transmission type.

The preceding description applies to uplink data (from the mobile terminal 30 to the central node 10). For downlink data, the same data transmission routes are followed, except that the data transmission direction is different from that followed by uplink data. Therefore, for the same transmission route, the transmission types of uplink data and downlink data in the same acceleration node are the same.

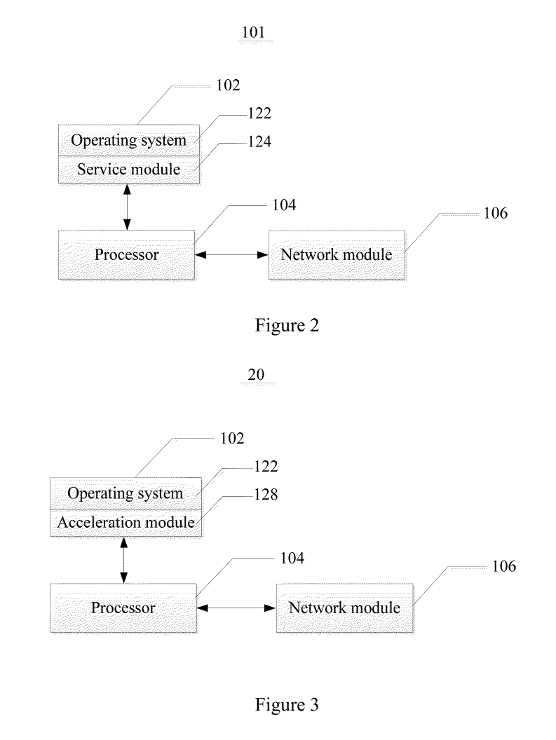

FIG. 2 shows the structural block diagram for an embodiment of the server in the central node 10. As shown in FIG. 2, the server 101 comprises the memory 102, the processor 104, and the network module 106. It may be understood that the structure as shown in FIG. 2 is only schematic, instead of limiting the structure of the server 101. For example, the server 101 may further include more or less components than those shown in FIG. 2, or components with configurations different from those shown in FIG. 2.

The memory 102 may be configured to store software programs and modules. The processor 104 executes function applications and data processing by running the software programs and modules stored in the memory 102. The memory 102 may include a high-speed RAM and a nonvolatile memory, for example, one or more magnetic memory devices, flash memory, or any other nonvolatile solid memory. In certain embodiments, the memory 102 may further include memories set remotely relative to the processor 104. These remote memories may be connected to the server 101 by using a network. The above-mentioned networks include, but are not limited to, the Internet, intranets, local area networks (LANs), mobile communications networks, and a combination of them.

The transmission module 106 may be configured to receive and send network signals. The above-mentioned signals may include wireless signals and wired signals. In an embodiment, the above-mentioned network signals are wired network signals. In this case, the transmission module 106 may include components such as the processor, RAM, converter, and crystal oscillator.

The above-mentioned software programs and modules include the operating system 122 and service module 124. Wherein, the operating system 122 may be Linux, Unix, or Windows, which may include various kinds of software components and/or drivers configured to manage system tasks (such as memory management, storage device control, and power management) and can communicate with hardware or software components, thereby improving the operation environment of other software components. Running on the operating system 124, the service module 122 listens on requests from networks by using the network services provided by the operating system 122, completes the corresponding data processing, and returns the processing results to the client. That is, by using a network, the service module 124 provides a network service, for example, the network communication service, for exchanging data such as text, voice, and videos between users.

FIG. 3 shows the structural block diagram of the acceleration node 20 in an embodiment as stated above. A comparison between FIG. 2 and FIG. 3 shows that the acceleration node 20 and the server 101 have similar hardware structures, with the only difference being that the memory 102 comprises the acceleration module 128. The acceleration module 128 listens on requests from networks by using the network services provided by the operating system 122, completes the corresponding data processing according to the requests, and return processing results to clients. Specifically, the acceleration module 128 can receive the data sent by the mobile terminal 30 or other acceleration node 20 and forward said data to the server 101 or other acceleration nodes 20.

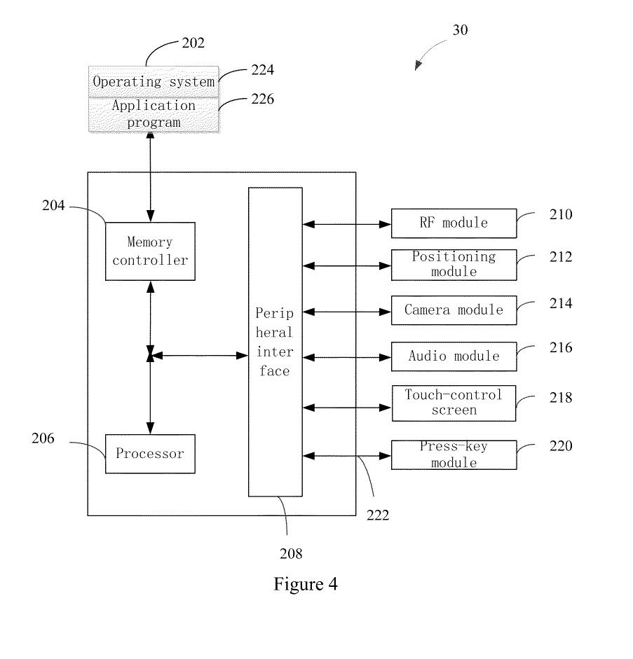

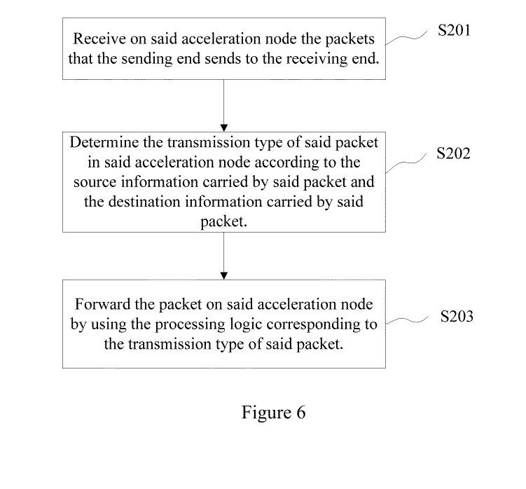

FIG. 4 shows the structural block diagram for an embodiment of the above-mentioned mobile terminal 30. As shown in FIG. 6, the mobile terminal 30 comprises the memory 202, the memory controller 204, one or more processors 206 (only one processor shown in the figure), the peripheral interface 208, the RF module 210, the positioning module 212, the camera module 214, the audio module 216, the touch-control module 218, and the press-key module 220. These components communicate with one another by using one or more communication buses/signal lines 222.

It may be understood that the structure as shown in FIG. 4 is only schematic. The mobile terminal 30 can also comprise more or less components than those as shown in FIG. 4 or components with configurations different from those as shown in FIG. 6. The components as shown in FIG. 4 may be implemented by using hardware, software, or a combination of hardware and software.

The memory 202 may be configured to store software programs and modules. The processor 206 executes function applications and data processing by running the software programs and modules stored in the memory 202. The memory 202 may include a high-speed RAM and a nonvolatile memory, for example, one or more magnetic memory devices, flash memory, or any other nonvolatile solid memory. In certain embodiments, the memory 202 can further comprise memories set remotely relative to the processor 206. These remote memories may be connected to the mobile terminal 30 by using a network. The above-mentioned networks include, but are not limited to, the Internet, intranets, LANs, mobile communications networks, and a combination of them. The processor 206 and other possible components can access the memory 202 under the control of the memory controller 204.

Those of ordinary skill in the existing art can understand that, relative to the processor 206, all the other components are peripherals. The processor 206 is coupled with these peripherals by using multiple peripheral interfaces 208. The peripheral interface 208 may be implemented using standards including, but not limited to, Universal Asynchronous Receiver/Transmitter (UART), General Purpose Input Output (GPIO), Serial Peripheral Interface (SPI), and Inter-Integrated Circuit (I2C). In certain embodiments, the peripheral interface 208 may include only a bus. In other embodiments, the peripheral interface 208 can further comprise other components, such as one or more controllers, including a display controller configured to connect an LCD panel or a memory controller configured to connect a memory. In addition, said controller may be separated from the peripheral interface 208 and integrated in the processor 206 or the corresponding peripheral. That is, in certain embodiments, the peripheral interface 208, the processor 206, and the memory controller 204 may be implemented using a single chip. In some other embodiments, the above-mentioned modules may be implemented respectively using an independent chip.

The RF module 210 is configured to receive and send electromagnetic waves and complete conversion between electromagnetic waves and electrical signals, thereby communicating with communications networks or other devices. The RF module 210 may include a variety of existing circuit components configured to execute these functions. Such circuit components include antennas, RF transceivers, digital signal processors, encryption/decryption chips, subscriber identity modules (SIMs), and memories. The RF module 210 can communicate with a variety of networks, such as the Internet, intranets, and wireless networks or communicate with other devices by using wireless networks. The above-mentioned wireless networks can include cellular phone networks, LANs, and metropolitan area networks (MANs). The above-mentioned wireless networks can adopt a variety of communications standards, protocols, and technologies, including, but not limited to, Global System for Mobile Communication (GSM), (Enhanced Data GSM Environment, EDGE), Wideband Code Division Multiple Access (W-CDMA), Code division Multiple Access (CDMA), Time Division Multiple Access (TDMA), Bluetooth, Wireless Fidelity (WiFi) (such as IEEE 802.11a, IEEE 802.11b, IEEE802.11g, and/or IEEE 802.11n), Voice over Internet Protocol (VoIP), Worldwide Interoperability for Microwave Access (Wi-Max), other protocols used for Emails, instant messaging, and short messages, any other applicable communications protocols, and even the protocols still under development.

The positioning module 212 is configured to obtain the information about the current location of the mobile terminal 20. For example, the positioning module 212 can receive the positioning signals broadcast by satellites and calculate its own position based on said positioning signals. The above-mentioned position may be expressed using a longitude, latitude, and altitude. The satellite positioning systems that may be used include the Global Positioning System (GPS), Compass Navigation Satellite System (CNSS), and Global Navigation Satellite System (GLONASS). The positioning module 212 can use not only satellite positioning technologies but also wireless positioning technologies, such as positioning technologies based on wireless base stations and positioning technologies based on wireless hotspots. In this case, the positioning module 212 may be substituted by the corresponding module or directly implemented by the processor 206 by executing a specific positioning program.

The camera module 214 is configured to take photos and videos. Taken photos or videos may be stored in the memory 202 and sent by using the RF module 210. The camera module 214 specifically may include components including a lens module, image sensor, and flashlight. The lens module is configured to form images of shot objects and map formed images to the image sensor. The image sensor is configured to receive the rays of light from the lens module to achieve photosensitivity for recording image information. Specifically, the image sensor may be implemented on the basis of the Complementary Metal Oxide Semiconductor (CMOS) technology, Charge-coupled Device (CCD) technology, and other image sensing principles. The flashlight is used for exposure compensation during picture taking. Generally, the flashlight of the mobile terminal 20 may be a Light Emitting Diode (LED) flashlight.

The audio module 216 provides audio interfaces, including one or more microphones, one or more loudspeakers, and audio circuits. The audio circuit receives audio data from the peripheral interface 208, converts the audio data into electric signals, and then sends the electric signals to the loudspeaker. The loudspeaker converts the electric signals into audible sound waves. The audio circuit further receives electric signals from a microphone, converts the electric signals into audio data, and transfers the audio data to the peripheral interface 208 for further processing. Audio data may be obtained from the memory 202 or by using the RF module 210. In addition, audio data can also be stored in the memory 202 or sent by using the RF module 210. In certain embodiments, the audio module 216 can further comprise a headset jack configured to provide an audio interface for headsets and other devices.

The touch-control screen 218 concurrently provides an output/input interface between the mobile terminal 30 and the user. Specifically, the touch-control screen 218 displays visual output to the user. Such visual output may be text, graphics, videos, or a combination of them. Certain output results correspond to certain user interface objects. The touch-control screen 218 further receives user input, such as clicking, sliding, and other gesture operations, allowing user interface objects to respond to such user input. The technology configured to detect user input may be a resistance touch-control detection technology, a capacitance touch-control detection technology, or any other possible touch-control detection technology. Embodiments of the display unit of the touch-control screen 218 include, but are not limited to, liquid crystal displays (LCDs) and light-emitting polymer displays. In other embodiments, the touch-control screen 218 can further be substituted by other types of display devices, for example, including a projected display device. Compared with common display panels, a projected display device further needs to comprise certain components used for projection, for example, a lens.

The press-key module 220 also provides an interface on which the user can input data into the mobile terminal 20. When the user presses a key, the mobile terminal 20 performs the corresponding function.

The software programs and modules stored in the memory 202 may include the operating system 224 and the application program 226. The operating system 224, for example, may be any operating system that can run on mobile terminals, such as Google Android operating system, Apple iOS operating system, and Microsoft Windows Mobile operating system. The application program 226 runs on the basis of the operating system 224. In an embodiment, the application program 226 may include a network communication program that provides the function of sending text, audios, and videos to contacts. It may be understood that text may be collected by using the touch-control screen 218 or the press-key module 220, that voice may be input by using the audio module 216, and that videos may be recorded in real time by using the camera module 214 and the audio module 216. After a user input operation triggers the preset sending operation, the received data is sent to the central node 10 to complete the communication function. The process is as follows:

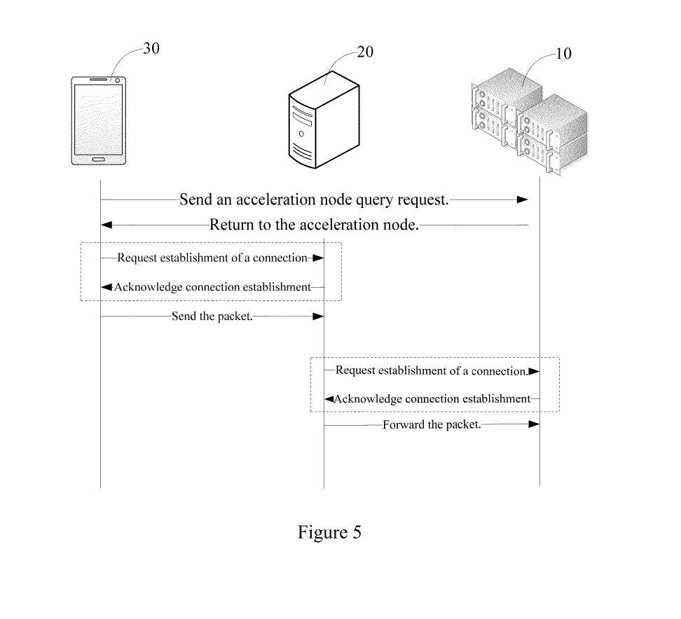

FIG. 5 shows the schematic diagram for the interaction time sequence when the data transmission system 100, as shown in FIG. 1, transmits data. As shown in FIG. 5, before actually sending data, the application program 226 installed on the mobile terminal 30 sends an acceleration node query request to the central node 10. Said acceleration node query request may be based on the Hypertext Transfer Protocol (HTTP), Domain Name System (DNS), or any other protocol that may be used for data transfer. Specifically, said acceleration node query request is sent to the server 101.

In an embodiment, on receiving an acceleration node query request sent by the mobile terminal 30, the server 101 parses the Internet Protocol (IP) address contained in said acceleration node request, determines the geographical location of said mobile terminal 30 based on the IP address, obtains the IP address of the acceleration node 20 nearest the mobile terminal 30, and returns said IP address to the mobile terminal 30.

In another embodiment, the above-mentioned mobile terminal 30 may determine its own geographical location by using its positioning module 212 and add said geographical location to said acceleration node query request. Thus, the server 101 may search and return the IP address of the nearest acceleration node 20 directly based on the geographical location contained in said acceleration node query request, without the need of again determining the location of the mobile terminal 30 based on an IP address.

On receiving the IP address of the nearest acceleration node 20 returned by the server 101, the mobile terminal 30 sends a request to said acceleration node 20 for establishing a network connection. The above-mentioned network connection may be a long connection, such as a Transfer Control Protocol (TCP) connection. It may be understood that, after a connection is established, said established connection may be used for any subsequent data transmission, without the need of reestablishing a network connection each time data is to be sent. In addition, the port used for the network connection established between the mobile terminal 30 and the acceleration node 20 may be within the preset port range. Network connections may be established between multiple mobile terminals 30 and the acceleration node 20. Therefore, in the acceleration node 20, each established connection may be associated with the Universal Identification Number (UIN) of the mobile terminal 30. Thus, by using the UIN of the mobile terminal 30, it may be determined through which network connection data may be sent to the corresponding mobile terminal 30.

When data needs to be sent, for example, when the user inputs texts or a voice clip in the dialog box provided the application program 226 and triggers the send condition, for example, by clicking the preset button or stopping speaking, the application program 226 encapsulates the content to be sent into a packet according to the preset protocol and sends said packet by using an established network connection. Generally, a packet may include the header and the body. The header may include the information about the central node 10 to which said packet is sent and other control information, such as whether said packet is fragmented. If said packet is fragmented, the header may also include the original packet identifier configured to reassemble multiple packet fragments. The packet body may include the above-mentioned texts or the data with the voice encoded.

Accordingly, the acceleration node 20 receives said packet. On receiving said packet, the acceleration node 20 can first verify the integrity of said packet. If the verification is passed, the acceleration node 20 proceeds with subsequent transmission; otherwise, the acceleration node 20 ignores said packet or requests the mobile terminal 30 to resend said packet.

In an embodiment, the acceleration node 20 can parse the header of a packet to obtain the following information: source port number and destination IP address of said packet.

The data received by the acceleration node 20 is sourced from either the mobile terminal 30 or other acceleration node 20. As described above, the port used for the network connection established between the mobile terminal 30 and the acceleration node 20 is within the preset port range. Similarly, the network connection established between the acceleration node 20 and the central node 10 and that between said acceleration node 20 and other acceleration node 20 can also be within respectively port ranges. Therefore, whether a packet is sent by the central node 10, the acceleration node 20, or the mobile terminal 30 may be determined on the basis of the port range within which the source port number of said packet falls.

Further, said destination IP address of and the IP address of the preset central node 10 may be compared to determine whether said packet is destined for the central node 10. If a match is found, said packet is destined for the central node 10; otherwise, said packet is destined for other acceleration node 20 or mobile terminal 30.

It may be understood that the acceleration node 20 can also be configured to transmit downlink packets (from the central node 10 to the mobile terminal 30). Sources of downlink packets also may be determined on the basis of the source port numbers of the downlink packets. The acceleration node 20 further can parse a packet to obtain the destination IP address and compares it with the stored IP addresses of acceleration nodes 20. If a match is found, said packet is destined for other acceleration node 20; otherwise, said packet is destined for the mobile terminal 30.

For the data to be sent to the central node 10 or other acceleration node 20, if a network connection has been established between the acceleration node 20 and the central node 10 or other acceleration node 20, the established network connection may be directly used; otherwise, a network connection is established first. It may be understood that a network connection established with the central node 10 or other acceleration node 20 can also fall within respective preset ranges.

Based on the data transmission system described in the present embodiment, the data sent by a mobile terminal may be quickly sent to a central node, thereby accelerating network communication.

FIG. 6 shows the flowchart of the method provided by embodiments for data transmission in the network system. The method described in the present embodiment may be used in the acceleration node 20 as shown in FIG. 1. As shown in FIG. 6, the method provided by the present embodiment comprises the following steps:

Step S201: Receive, at said acceleration node, a packet that is sent from a sending end to a receiving end.

In an embodiment, the packet is an uplink packet; the sending end may be, for example, the mobile terminal 30 or another acceleration node 20 as shown in FIG. 1; the receiving end is another acceleration node 20 or central node 10 as shown in FIG. 1. As shown in FIG. 1, the acceleration node 20 is located between said sending end and receiving end. Therefore, at least one of the sending end and the receiving end is the central node 10 or the acceleration node 20.

Step S202: Determine the transmission type of said packet in said acceleration node according to the source information of said packet and the destination information of said packet.

In one acceleration node 20, if the received packet is sourced from the mobile terminal 30 used by a user and destined for another acceleration node 20, the transmission type of said packet in the acceleration node 20 is access.

In one acceleration node 20, if the received packet is sourced from another acceleration node 20 and destined for yet another acceleration node 20, the transmission type of said packet in the acceleration node 20 is transfer.

In one acceleration node 20, if the received packet is sourced from the mobile terminal 30 used by the user and destined for the central node 10, the transmission type of said packet in the acceleration node 20 is hybrid.

In one acceleration node 20, if the received packet is sourced from other acceleration node 20 and destined for the central node 10, the transmission type of said packet in the acceleration node 20 is delivery.

The sources and destinations of packets may be identified according to the information contained in said packets, such as source port numbers, source IP addresses, and destination IP addresses.

Step S203: Forward the packet at said acceleration node by using the processing logic corresponding to the transmission type of said packet.

An acceleration node 20 uses different processing logics to process a packet based on transmission types. For example, packets are sent by using a transmission channel corresponding to the transmission type or by using different sending modes depending on the transmission type. In an embodiment, the acceleration node 20 reads a route configuration file and, based on the current transmission type, obtains the next node to which the current packet needs to be sent. Said node may be the central node 10 or other acceleration node 20. After the next node is obtained, the packet is sent to said next node by using a newly established or an existing network connection.

Based on the method described in the present embodiment, the data sent by the sending end may be quickly forwarded to the receiving end, thereby accelerating network communication.

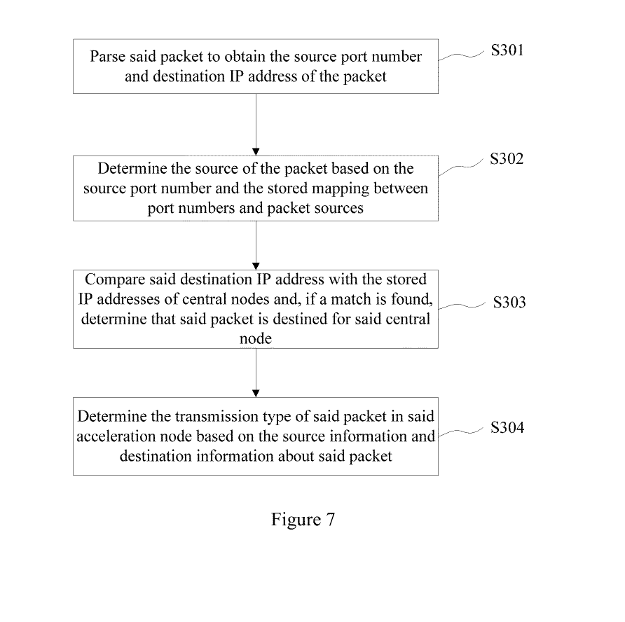

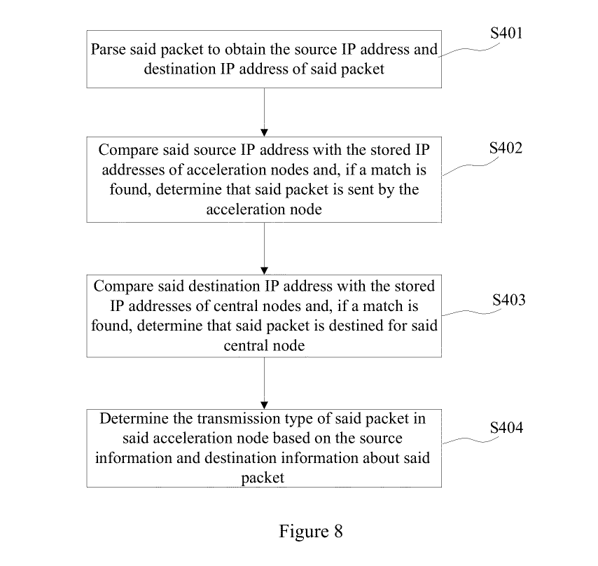

The embodiments provide a method for data transmission in a network system. This method is similar to the one shown in FIG. 8; for details about the difference, see FIG. 7. Step S202 comprises the following steps:

Step S301: Parse said packet to obtain the source port number and destination IP address of said packet;

If encrypted, said packet is decrypted first. Then, the header of said packet is parsed to obtain the source port number and destination IP address.

Step S302: Determine the source of the packet based on said source port number and the stored mapping between port numbers and packet sources.

As described above, the port numbers used for the network connection between the mobile terminal 30 and the acceleration node 20, the network connection between the acceleration node 20 and other acceleration node 20, and the network connection between the acceleration node 20 and the central node 10 fall within respective preset ranges. That is, the mapping between ports and packet sources is decided. The source of the packet is determined on the basis of said source port number and the stored mapping between port numbers and packet sources. If the packet is sourced from the dedicated port of the mobile terminal 30, said packet is sent by the mobile terminal 30; if the packet is sourced from the dedicated port of the acceleration node 20, said packet is sent by other acceleration node 20; if the packet is sourced from the dedicated port of the central node 10, said packet is sent by the central node 10.

Step S303: Compare said destination IP address with the stored IP address of the central node and, if a match is found, determine that said packet is destined for said central node.

Generally, once decided, the IP address of the central node 10 seldom changes. The IP address of the central node 10 may be stored in a configuration file on the acceleration node 20. The stored IP address of the central node 10 may be obtained and the destination IP address contained in a packet compared with the stored IP addresses to determine whether said packet is destined for the central node 10. If a match is found, said packet is destined for the central node 10.

Step S304: Determine the transmission type of said packet in said acceleration node based on the source information and destination information about said packet.

After the source and destination of said packet are obtained, the transmission type of said packet in the current acceleration node 20 may be determined.

In one acceleration node 20, if the received packet is sourced from the mobile terminal 30 used by a user and destined for other acceleration node 20, the transmission type of said packet in the acceleration node 20 is access.

In one acceleration node 20, if the received packet is sourced from another acceleration node 20 and destined for yet another acceleration node 20, the transmission type of said packet in the acceleration node 20 is transfer.

In one acceleration node 20, if the received packet is sourced from the mobile terminal 30 used by a user and destined for the central node 10, the transmission type of said packet in the acceleration node 20 is hybrid.

In one acceleration node 20, if the received packet is sourced from another acceleration node 20 and destined for the central node 10, the transmission type of said packet in the acceleration node 20 is delivery.

According to the method provided by the present embodiment, the source of a packet may be determined quickly based on the source port number of said packet, regardless of whether the IP address of the acceleration node 20 or that of the central node 10 has changed. Generally, the IP addresses of the central node 10 are few and seldom change; thereby they can also be configured to quickly determine the destinations of packets.

The embodiments provide a method for data transmission in a network system. Said method is similar to the method as shown in FIG. 8; for details about the difference, see FIG. 8. Step S202 comprises the following steps:

Step S401: Parse said packet to obtain the source IP address and destination IP address of said packet.

If encrypted, said packet is decrypted first. Then, the header of said packet is parsed to obtain the source IP address and destination IP address.

Step S402: Compare said source IP address with the stored IP addresses of the acceleration nodes and, if a match is found, determine that said packet is sent by the acceleration node.

Generally, the IP address of the acceleration node 20 seldom is relatively fixed. If the number of acceleration nodes 20 keeps increasing, the IP addresses of acceleration nodes 20 seldom change. The IP address of the central node 10 may be stored in a configuration file. The stored IP address of the acceleration node 20 may be obtained and the source IP address contained in a packet compared with the stored IP addresses to determine whether said packet is sourced from other acceleration node 20. If a match is found, said packet is sent by the acceleration node 20. If not sent by other acceleration node 20, an uplink packet is sent by the mobile terminal 30.

Step S403: Compare said destination IP address with the stored IP address of the central node and, if a match is found, determine that said packet is destined for said central node.

Generally, once decided, the IP address of the central node 10 seldom changes. The IP address of the central node 10 may be stored in a configuration file on the acceleration node 20. The stored IP address of the central node 10 may be obtained and the destination IP address contained in a packet compared with the stored IP addresses to determine whether said packet is destined for the central node 10. If a match is found, said packet is destined for the central node 10. If not destined for the central node 10, said packet is sent to other acceleration node 20.

Step S404: Determine the transmission type of said packet in said acceleration node based on the source information and destination information about said packet.

After the source and destination of said packet are obtained, the transmission type of said packet in the current acceleration node 20 may be determined.

In one acceleration node 20, if the received packet is sourced from the mobile terminal 30 used by a user and destined for another acceleration node 20, the transmission type of said packet in the acceleration node 20 is access.

In one acceleration node 20, if the received packet is sourced from another acceleration node 20 and destined for yet another acceleration node 20, the transmission type of said packet in the acceleration node 20 is transfer.

In one acceleration node 20, if the received packet is sourced from the mobile terminal 30 used by a user and destined for the central node 10, the transmission type of said packet in the acceleration node 20 is hybrid.

In one acceleration node 20, if the received packet is sourced from another acceleration node 20 and destined for the central node 10, the transmission type of said packet in the acceleration node 20 is delivery. According to the method provided by the present embodiment, the source and destination of said packet may be quickly determined based on the source IP address and destination IP address of said packet. Thus, the role currently played by said acceleration node is determined so that the data processing is performed accordingly.

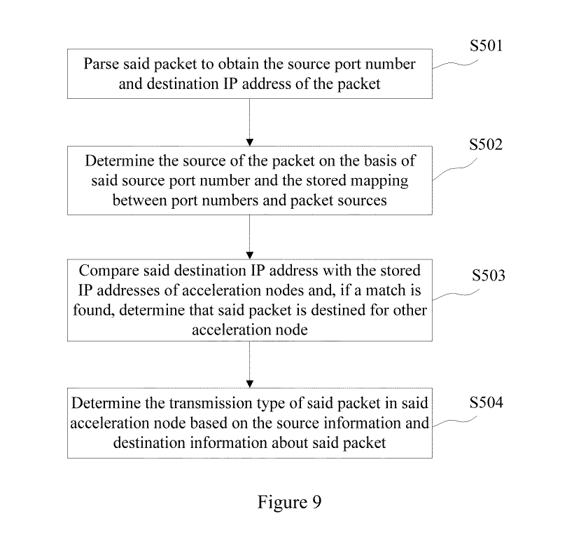

The embodiments provide a method for data transmission in a network system. The method is similar to the one shown in FIG. 8; for details about the difference, see FIG. 9. Step S202 comprises the following steps:

Step S501: Parse said packet to obtain the source port number and destination IP address of said packet.

If encrypted, said packet is decrypted first. Then, the header of said packet is parsed to obtain the source port number and destination IP address.

Step S502: Determine the source of the packet based on said source port number and the stored mapping between port numbers and packet sources.

If the packet is sourced from the dedicated port of the mobile terminal 30, said packet is sent by the mobile terminal 30; if the packet is sourced from the dedicated port of the acceleration node 20, said packet is sent by other acceleration node 20; if the packet is sourced from the dedicated port of the central node 10, said packet is sent by the central node 10.

Step S503: Compare said destination IP address with the stored IP addresses of the acceleration nodes and, if a match is found, determine that said packet is destined for other acceleration node.

Generally, the IP address of the acceleration node 20 seldom is relatively fixed. If the number of acceleration nodes 20 keeps increasing, the IP addresses of acceleration nodes 20 seldom change. The IP address of the central node 10 may be stored in a configuration file. The stored IP address of the acceleration node 20 may be obtained and the source IP address contained in a packet compared with the stored IP addresses to determine whether said packet is destined for other acceleration node 20. If a match is found, said packet is destined for the acceleration node 20. If not destined for another acceleration node 20, a downlink packet is destined for the mobile terminal 30.

Step S504: Determine the transmission type of said packet in said acceleration node based on the source information and destination information about said packet.

In one acceleration node 20, for downlink packets, if the received packet is sourced from another acceleration node 20 and destined for the mobile terminal 30, the transmission type of said packet in the acceleration node 20 is access; if the received packet is sourced from the central node 10 and destined for the mobile terminal 30, the transmission type of said packet in the acceleration node 20 is hybrid; if the received packet is sourced from another acceleration node 20 and also destined for another acceleration node 20, the transmission type of said packet in the acceleration node 20 is transfer; if the received packet is sourced from the central node 10 and destined for another acceleration node 20, the transmission type of said packet in the acceleration node 20 is transmission

According to the method provided by the present embodiment, the role currently played by an acceleration node may be quickly determined so that data processing is performed accordingly.

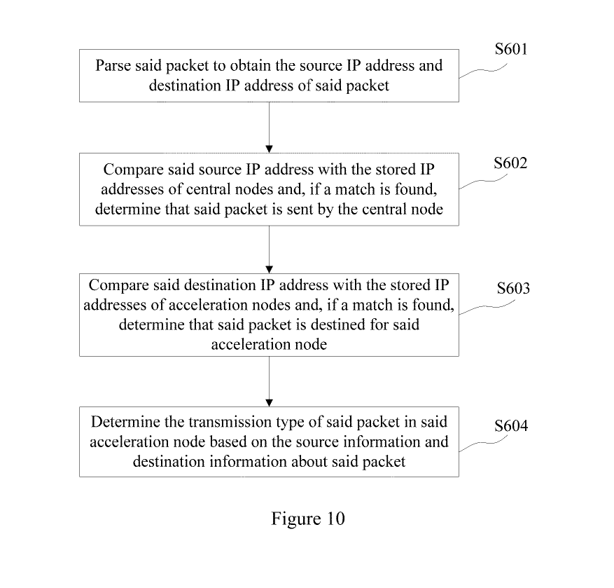

The embodiments provide a method for data transmission in a network system. The method is similar to the one shown in FIG. 8; for details about the difference, see FIG. 10. Step S202 comprises the following steps:

Step S601: Parse said packet to obtain the source IP address and destination IP address of said packet.

If encrypted, said packet is decrypted first. Then, the header of said packet is parsed to obtain the source IP address and destination IP address.

Step S602: Compare said source IP address with the stored IP addresses of central nodes and, if a match is found, determine that said packet is sent by the central node;

Generally, once decided, the IP address of the central node 10 seldom changes. The IP address of the central node 10 may be stored in a configuration file on the acceleration node 20. The stored IP address of the central node 10 may be obtained and the source IP address contained in a packet compared with the stored IP addresses to determine whether said packet is sent by the central node 10. If a match is found, said packet is sent by the central node 10. For downlink messages, a packet is sent by either the central node 10 or other acceleration node 20.

Step S603: Compare said destination IP address with the stored IP addresses of the acceleration nodes and, if a match is found, determine that said packet is destined for said acceleration node.

Generally, the IP address of the acceleration node 20 seldom is relatively fixed. If the number of acceleration nodes 20 keeps increasing, the IP addresses of acceleration nodes 20 seldom change. The IP address of the central node 10 may be stored in a configuration file. The stored IP address of the acceleration node 20 may be obtained and the destination IP address contained in a packet compared with the stored IP addresses to determine whether said packet is destined for other acceleration node 20. If a match is found, said packet is destined for the acceleration node 20. If not destined for other acceleration node 20, a downlink packet is destined for the mobile terminal 30.

Step S604: Determine the transmission type of said packet in said acceleration node based on the source information and destination information about said packet.

In one acceleration node 20, for a downlink packet, if the received packet is sourced from another acceleration node 20 and destined for the mobile terminal 30, the transmission type of said packet in the acceleration node 20 is access; if the received packet is sourced from the central node 10 and destined for the mobile terminal 30, the transmission type of said packet in the acceleration node 20 is hybrid; if the received packet is sourced from another acceleration node 20 and also destined for another acceleration node 20, the transmission type of said packet in the acceleration node 20 is transfer; if the received packet is sourced from the central node 10 and destined for another acceleration node 20, the transmission type of said packet in the acceleration node 20 is transmission

According to the method provided by the present embodiment, the role currently played by an acceleration node may be quickly determined so that data processing is performed accordingly.

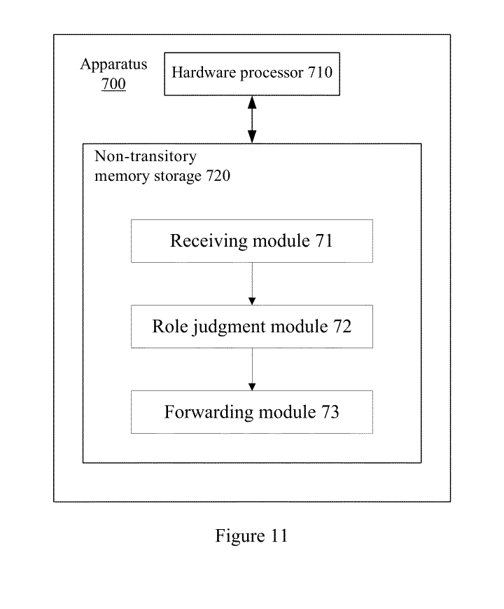

Embodiments provide a device for data transmission in a network system. As shown in FIG. 11, the example device 700 includes a hardware processor 710 and a non-transitory storage medium 720 configured to store modules: a receiving module 71, a transmission type determination module 72, and a forwarding module 73.

The receiving module 71 is configured to receive, at said acceleration node, a packet that is sent from a sending end to a receiving end. In an embodiment, the packet can an uplink packet; the sending end may be, for example, the mobile terminal 30 or another acceleration node 20 as shown in FIG. 1; the receiving end is another acceleration node 20 or central node 10 as shown in FIG. 1. As shown in FIG. 1, the acceleration node 20 is located between said sending end and receiving end. Therefore, at least one of the sending end and the receiving end is the central node 10 or the acceleration node 20.

The transmission type determination module 72 is configured to determine the transmission type of said packet in said acceleration node according to the source information of said packet and the destination information of said packet.

For an uplink packet, if the received packet is sourced from the mobile terminal 30 used by the user and destined for another acceleration node 20, the transmission type of said packet in the acceleration node 20 is access; if the received packet is sourced from other acceleration node 20 and destined for another acceleration node 20, the transmission type of said packet in the acceleration node 20 is transfer; if the received packet is sourced from the mobile terminal 30 used by a user and destined for the central node 10, the transmission type of said packet in the acceleration node 20 is hybrid; if the received packet is sourced from another acceleration node 20 and destined for the central node 10, the transmission type of said packet in the acceleration node 20 is delivery.

In one acceleration node 20, for a downlink packet, if the received packet is sourced from another acceleration node 20 and destined for the mobile terminal 30, the transmission type of said packet in the acceleration node 20 is access; if the received packet is sourced from the central node 10 and destined for the mobile terminal 30, the transmission type of said packet in the acceleration node 20 is hybrid; if the received packet is sourced from another acceleration node 20 and also destined for another acceleration node 20, the transmission type of said packet in the acceleration node 20 is delivery; if the received packet is sourced from the central node 10 and destined for another acceleration node 20, the transmission type of said packet in the acceleration node 20 is transmission

The forwarding module 73 is configured to forward the packet at said acceleration node by using the processing logic corresponding to the transmission type of said packet.

An acceleration node 20 uses different processing logics to process a packet based on transmission types. For example, packets are sent by using a transmission channel corresponding to the transmission type or by using different sending modes depending on the transmission type. In an embodiment, the acceleration node 20 reads a route configuration file and, based on the current role, obtains the next node to which the current packet needs to be sent. The node may be the central node 10 or another acceleration node 20. After the next node is obtained, the packet is sent to the next node by using a newly established or existing network connection.

Based on the method described in the present embodiment, the data sent by the sending end may be quickly forwarded to the receiving end, thereby accelerating network communication.

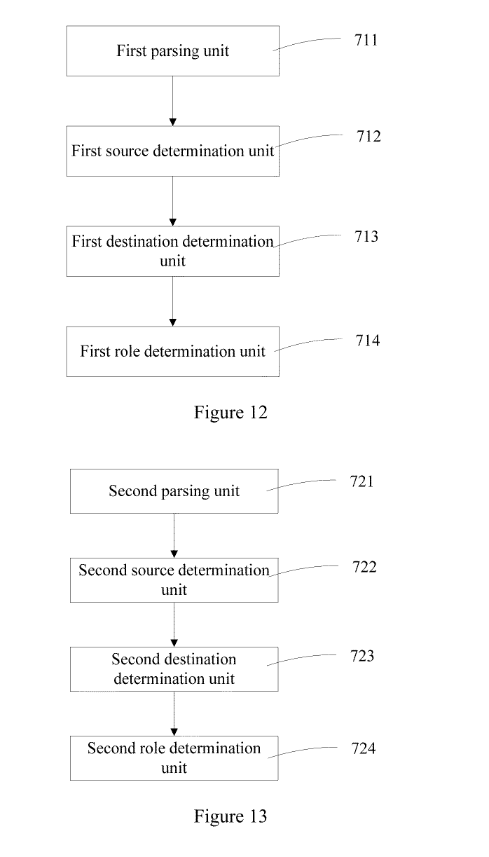

Embodiments provide a device for data transmission in a network system, which is similar to the one shown in FIG. 11. The difference is that, as shown in FIG. 12, the transmission type determination module 72 comprises a first parsing unit 711, a first source determination unit 712, a first role determination unit 713, and a first role determination unit 714.

The first parsing unit 711 is configured to parse said packet to obtain the source port number and destination IP address of said packet.

The first source determination unit 712 is configured to determine the source of the packet based on said source port number and the stored mapping between port numbers and packet sources.

The first destination determination unit 713 is configured to compare said destination IP address with the stored IP address of the central node and, if said IP addresses match, determine that said packet is destined for said central node.

The first role determination unit 714 is configured to determine the transmission type of said packet in said acceleration node according to the determination results obtained by said first source determination unit 712 and first destination determination unit 713.

For other details about the device provided the present embodiment, see FIG. 7 and relevant descriptions.

According to the device provided by the present embodiment, the source of a packet may be determined quickly based on the source port number of said packet, regardless of whether the IP address of the acceleration node 20 or that of the central node 10 has changed. Generally, the IP addresses of the central node 10 are few and seldom change; thereby they can also be configured to quickly determine the destinations of packets.

Embodiments provide a device for data transmission in a network system, which is similar to the one shown in FIG. 11. The difference is that, as shown in FIG. 13, the transmission type determination module 72 comprises a second parsing unit 721, a second source determination unit 722, a second role determination unit 723, and a second role determination unit 724.

The second parsing unit 721 is configured to parse said packet to obtain the source IP address and destination IP address of said packet.

The second source determination unit 722 is configured to compare said source IP address with the stored IP addresses of acceleration nodes and, if a match is found, determine that said packet is sent by the acceleration node.

The second destination determination unit 723 is configured to compare said destination IP address with the stored IP address of the central node and, if said IP addresses match, determine that said packet is destined for said central node.

The second role determination unit 724 is configured to determine the transmission type of said packet in said acceleration node according to the determination results obtained by said second source determination unit 722 and second destination determination unit 723.

For other details about the device provided the present embodiment, see FIG. 8 and relevant descriptions.

According to the device provided by the present embodiment, the source and destination of a packet may be quickly determined based on the source IP address and destination IP address of the packet. Thus, the role currently played by an acceleration node is determined so that data processing is performed accordingly.

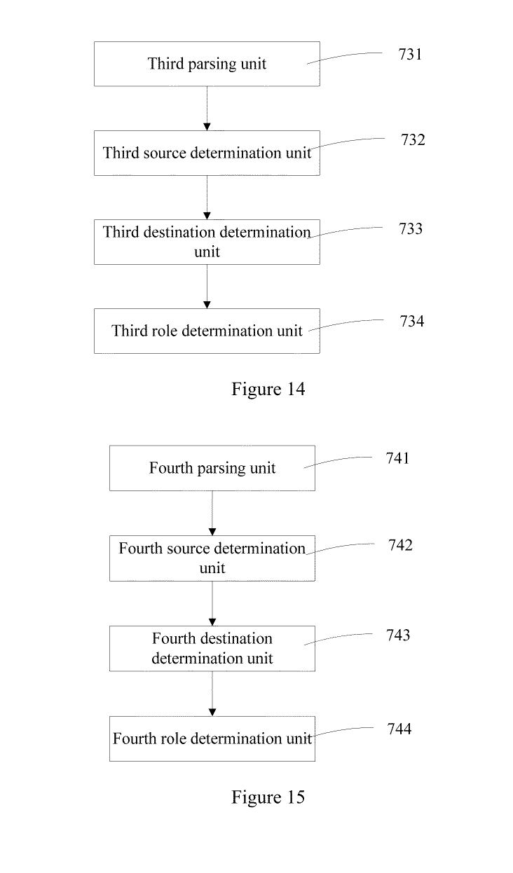

Embodiments provide a device for data transmission in a network system, which is similar to the one shown in FIG. 11. The difference is that, as shown in FIG. 14, the transmission type determination module 72 comprises a third parsing unit 731, a third source determination unit 732, a third role determination unit 733, and a third role determination unit 734.

The third parsing unit 731 is configured to parse said packet to obtain the source port number and destination IP address of said packet.

The third source determination unit 732 is configured to determine the source of the packet based on said source port number and the stored mapping between port numbers and packet sources.

The third destination determination unit 733 is configured to compare said destination IP address with the stored IP addresses of acceleration nodes and, if a match is found, determine that said packet is destined for another acceleration node.

The third role determination unit 734 is configured to determine the transmission type of said packet in said acceleration node according to the determination results obtained by said third source determination unit 732 and third destination determination unit 733.

For other details about the device provided the present embodiment, see FIG. 9 and relevant descriptions.

According to the device provided by the present embodiment, the role currently played by an acceleration node may be quickly determined so that data processing is performed accordingly.

Embodiments provide a device for data transmission in a network system, which is similar to the one shown in FIG. 11. The difference is that, as shown in FIG. 15, the transmission type determination module 72 comprises a fourth parsing unit 741, a fourth source determination unit 742, a fourth role determination unit 743, and a fourth role determination unit 744.

The fourth parsing unit 741 is configured to parse said packet to obtain the source IP address and destination IP address of said packet.

The fourth source determination unit 742 is configured to compare said source IP address with the stored IP address of the central node and, if a match is found, determine that said packet is sent by the central node.

The fourth destination determination unit 743 is configured to compare said destination IP address with the stored IP address of the acceleration node and, if said IP addresses match, determine that said packet is destined for said acceleration node.

The fourth role determination unit 744 is configured to determine the transmission type of said packet in said acceleration node according to the determination results obtained by said fourth source determination unit and fourth destination determination unit.

For other details about the device provided the present embodiment, see FIG. 10 and relevant descriptions.

According to the method provided by the present embodiment, the role currently played by an acceleration node may be quickly determined so that data processing is performed accordingly.

In addition, it may be understood that the description of the above-mentioned embodiments is only exemplary and is not intended to limit the method or device provided by the present disclosure. Those of ordinary skill in the art may obtain new technical solutions by combining and slightly altering the above-mentioned embodiments. Such technical solutions shall also fall into the scope of the above-mentioned method, device, and system.

In addition, the embodiments of the present disclosure further provide a computer-readable storage medium, with its memory storing computer-executable instructions. The computer-readable storage medium may be a nonvolatile memory, such as an optical disk, hard disk, and flash memory. The computer-executable instructions are executed to implement the above-mentioned method on computers or similar arithmetic devices.

While the present disclosure has been particularly disclosed and described above with reference to the preferred embodiments, it should be understood that the description is not intended to limit the present disclosure. Those of ordinary skill in the art may make equivalent embodiments with certain changes or modifications by utilizing the above-disclosed technical contents, without departing from the technical solution scope of the present disclosure. Any simple alterations, equivalent changes, or modifications made to the above-mentioned embodiments based on the technical essence of the present disclosure without departing from the technical solution contents of the present disclosure shall fall within the scope of the present disclosure.

Person of skill in the art can get aware that the whole or part of method in embodiments above may be realized through relevant hardware under instruction of computer program, in which the program may be stored in a computer-readable memory medium. When the program is executed, flow processes in embodiments of method above may be contained. Therein, the memory medium above may be diskette, optical disk, Read-Only Memory (ROM) or Random Access Memory (RAM), or the like.

All disclosures above are just some of the preferred embodiments of the disclosure, which are descried specifically and particularly but not intending to limit the range of the disclosure. It should be noticed that person of skill in the art can make various changes and modifications within the scope of the disclosure, therefore, the protection scope of the present disclosure is defined by the claims.

What is claimed is:

1. A method for data transmission in a network system, said network system comprising a central node and at least one acceleration node, wherein said method comprises:
receiving, at said acceleration node, a packet that is sent from a sending end to a receiving end, said acceleration node being located between said sending end and receiving end, and at least one of said sending end and receiving end being said central node or acceleration node;
determining a transmission type of said packet in said acceleration node according to source information about said packet and destination information about said packet; and
forwarding the packet at said acceleration node by using processing logic corresponding to the transmission type of said packet.

2. The method according to claim 1, wherein said determining the transmission type of said packet in said acceleration node according to the source information about said packet and the destination information about said packet comprises:
parsing said packet to obtain a source port number and a destination Internet Protocol (IP) address of said packet;
determining a source of the packet based on said source port number and a stored mapping between port numbers and packet sources;
comparing said destination IP address with a stored IP address of the central node and, if a match is found, determining that said packet is destined for said central node; and
determining the transmission type of said packet in said acceleration node based on the source information and the destination information about said packet.

3. The method according to claim 1, wherein said determination of the transmission type of said packet in said acceleration node according to the source information about said packet and the destination information about said packet comprises:
parsing said packet to obtain a source Internet Protocol (IP) address and a destination IP address of said packet;
comparing said source IP address with stored IP addresses of acceleration nodes and, if a match is found, determining that said packet is sent by the acceleration node;
comparing said destination IP address with the stored IP address of the central node and, if a match is found, determining that said packet is destined for said central node; and
Determining the transmission type of said packet in said acceleration node based on the source information and destination information about said packet.

4. The method according to claim 1, wherein: said determination of the transmission type of said packet in said acceleration node according to the source information about said packet and the destination information about said packet comprises:
parsing said packet to obtain a source port number and a destination Internet Protocol (IP) address of said packet;
determining the source of the packet based on said source port number and a stored mapping between port numbers and packet sources;
Comparing said destination IP address with stored IP addresses of acceleration nodes and, if a match is found, determining that said packet is destined for other acceleration node; and
determining the transmission type of said packet in said acceleration node based on the source information and destination information about said packet.

5. The method according to claim 1, wherein said determination of the transmission type of said packet in said acceleration node according to the source information about said packet and the destination information about said packet comprises:
parsing said packet to obtain a source Internet Protocol (IP) address and a destination IP address of said packet;
comparing said source IP address with a stored IP address of the central node and, if a match is found, determining that said packet is sent by the central node;
comparing said destination IP address with stored IP addresses of acceleration nodes and, if a match is found, determining that said packet is destined for said acceleration node; and
determining the transmission type of said packet in said acceleration node based on the source information and destination information about said packet.

6. A device for data transmission in a network system, said network system comprising a central node and at least one acceleration node, wherein said device comprises a hardware processor and a non-transitory storage medium configured to store modules comprising:
a receiving module, configured to receive, at said acceleration node, a packet that is sent from a sending end to a receiving end, said acceleration node being located between said sending end and receiving end, and at least one of said sending end and receiving end being said central node or acceleration node;
a determination module, configured to determine a transmission type of said packet in said acceleration node according to source information about said packet and destination information about said packet; and
a forwarding module, configured to forward the packet at said acceleration node by using a processing logic corresponding to the transmission type of said packet.

7. The device according to claim 6, wherein said determination module comprises:
a first parsing unit, configured to parse said packet to obtain a source port number and a destination Internet Protocol (IP) address of said packet;
a first source determination unit, configured to determine the source of the packet based on said source port number and the stored mapping between port numbers and packet sources;
a first destination determination unit, configured to compare said destination IP address with a stored IP address of the central node and, if a match is found, determine that said packet is destined for said central node; and
a first role determination unit, configured to determine the transmission type of said packet in said acceleration node according to determination results obtained by said first source determination unit and first destination determination unit.

8. The device according to claim 6, wherein said determination module comprises:
a second parsing unit, configured to parse said packet to obtain a source Internet Protocol (IP) address and destination IP address of said packet;
a second source determination unit, configured to compare said source IP address with a stored IP addresses of acceleration nodes and, if a match is found, determine that said packet is sent by the acceleration node;
a second destination determination unit, configured to compare said destination IP address with the stored IP address of the central node and, if a match is found, determine that said packet is destined for said central node; and
a second role determination unit, configured to determine the transmission type of said packet in said acceleration node according to determination results obtained by said second source determination unit and second destination determination unit.

9. The device according to claim 6, wherein said determination module comprises:
a third parsing unit, configured to parse said packet to obtain a source port number a destination Internet Protocol (IP) address of said packet;
a third source determination unit, configured to determine the source of the packet based on said source port number and the stored mapping between port numbers and packet sources;
a third destination determination unit, configured to compare said destination IP address with a stored IP addresses of acceleration nodes and, if a match is found, determine that said packet is destined for other acceleration node; and
a third role determination unit, configured to determine the transmission type of said packet in said acceleration node according to determination results obtained by said third source determination unit and third destination determination unit.

10. The device according to claim 6, wherein said determination module comprises:
a fourth parsing unit, configured to parse said packet to obtain a source Internet Protocol (IP) address and destination IP address of said packet;
a fourth source determination unit, configured to compare said source IP address with a stored IP address of the central node and, if a match is found, determine that said packet is sent by the central node;
a fourth destination determination unit, configured to compare said destination IP address with a stored IP addresses of acceleration nodes and, if a match is found, determine that said packet is destined for said acceleration node; and
a fourth role determination unit, configured to determine the transmission type of said packet in said acceleration node according to determination results obtained by said fourth source determination unit and fourth destination determination unit.

11. A data transmission system, comprising:
a sending end, a receiving end, and an acceleration node located between said sending end and receiving end;
said sending end is configured to send a packet destined for the receiving end to said acceleration node; and
said acceleration node is configured to receive a packet that is sent from said sending end to the receiving end, determine a transmission type of said packet in said acceleration node according to source information about said packet and destination information about said packet; forward said packet at said acceleration node by using a processing logic corresponding to the transmission type of said packet.

12. The data transmission system according to claim 11, wherein said determination of the transmission type of said packet in said acceleration node according to the source information of said packet and the destination information of said packet comprises:
parsing said packet to obtain a source port number and a destination Internet Protocol (IP) address of the packet;
determining a source of the packet based on the source port number and a stored mapping between port numbers and packet sources;
comparing said destination IP address with a stored IP address of a central node and, if a match is found, determining that said packet is destined for the central node; and
determining the transmission type of said packet in said acceleration node based on the source information and destination information about said packet.

13. The data transmission system according to claim 11, wherein said determination of the transmission type of said packet in said acceleration node according to the source information about said packet and the destination information about said packet comprises:
parsing said packet to obtain a source Internet Protocol (IP) IP address and destination IP address of said packet;
comparing said source IP address with a stored IP addresses of acceleration nodes and, if a match is found, determining that said packet is sent by the acceleration node;
comparing said destination IP address with the stored IP address of a central node and, if a match is found, determining that said packet is destined for the central node; and
determining the transmission type of said packet in said acceleration node based on the source information and destination information about said packet.

14. The data transmission system according to claim 11, wherein said determination of the transmission type of said packet in said acceleration node according to the source information about said packet and the destination information about said packet comprises:
parsing said packet to obtain a source port number and destination Internet Protocol (IP) address of the packet;
determining a source of the packet based on the source port number and a stored mapping between port numbers and packet sources;
comparing said destination IP address with a stored IP addresses of acceleration nodes and, if a match is found, determining that said packet is destined for other acceleration node; and
determining the transmission type of said packet in said acceleration node based on the source information and destination information about said packet.

15. The data transmission system according to claim 11, wherein said determination of the transmission type of said packet in said acceleration node according to the source information about said packet and the destination information about said packet comprises:
parsing said packet to obtain a source Internet Protocol (IP) address and destination IP address of said packet;
comparing said source IP address with a stored IP address of a central node and, if a match is found, determining that said packet is sent by the central node;
comparing said destination IP address with a stored IP addresses of acceleration nodes and, if a match is found, determining that said packet is destined for said acceleration node; and
determining the transmission type of said packet in said acceleration node based on the source information and destination information about said packet.
